(19) United States
(12) Patent Application Publication
(10) Pub. No.: US 2009/0292775 A1
(43) Pub. Date: Nov. 26, 2009

(54) Method and process for the Forensic Inspection of real time streams FIRST Engine

(76) Inventor: Scott Wayne Flenniken, Ladera Ranch, CA (US)

Correspondence Address: Scott Flenniken, 70 Sklar, #912 Ladera Ranch, Ladera Ranch, CA, 92694, US

(21) Appl. No.: 12/123,486

(22) Filed: May 20, 2008

(51) Int. Cl. G06F 15/16

(52) U.S. Cl. 709/206

(57) ABSTRACT

The present invention relates generally to a business method, computer system and software implemented method in the field of internet based security for facilitating the analysis and inspection of real time data streams, which will allow a user to actively monitor chat and email information. The present invention will inspect a plurality of user browsing information such as, but not limited to, the web pages and search queries respectively visited and submitted by users, the emails sent and received by users, and the manner in which users browse the Internet and search for content. More particularly the present invention facilitates the real time forensic inspection of data streams using pattern and keyword matching techniques.

### FIELD OF THE INVENTION

The present invention relates generally to a business method, computer system and software implemented method in the field of internet based security that provides for secure and high speed monitoring internet usage activity. More particularly the present invention facilitates the real time forensic inspection of data streams using pattern and keyword matching techniques.

### BACKGROUND OF THE INVENTION

As is known, the Internet typically refers to a number of data service systems connected together via a high speed interconnect network. Each data service system typically includes web or other content servers that host contents for various customers. The servers can also host applications. Each of the data service systems is typically implemented by a computer system (e.g., a server computer system). A number of remote user terminals may be connected to a data service system via an interconnect network (e.g., a telephone network). The remote user terminals are typically referred to as clients. This arrangement allows users at the user terminals to access the contents, services, and/or applications hosted in various data service systems. Each user terminal is equipped with a web browser that allows the user terminal to access the contents, services, and/or applications hosted in various data service systems.

More and more entities now have their own web sites and/or web pages. When a user accesses that site, the user can get news announcement, product information, and contact information, etc. The user may also be permitted to purchase products via that site. The user can also move to other pages to get even more information and/or service. In addition to this, a wide variety of new Internet-based media delivery platforms have also been developed. One reason the internet has become very popular is that it makes content access extremely easy. The Internet is popular for downloading and sharing content such as music files, movies, and the like. People want to share files over the internet Whether the files are simple web pages, audio clips such as MP3's, photographs, or other content, the preferred means for sharing files is via the web.

The rise in the usage of the Internet, however, has also had a negative side. Given the Internet's vastness and freedom, many individuals have taken the opportunity to profit by posting unwanted and obscene content online, which may be accessed by any individual irrespective of age. This poses serious threats to parental care and results in unnecessary exposure of innocent internet browsers to non ethical content on the Internet. The guardians have no way of identifying whether such unwanted content was accessed by their wards during their time on the Internet.

As of today, there is no existing mechanism that helps in the analysis of real time data streams on the Internet and identification of specific patterns. Similarly there is no existing mechanism that instantly notifies of the results of such forensic inspection if a pattern matching is identified. There also exists no existing mechanism that allows an improved system of generic matching.

Therefore there is a need for a method that allows the inspection of real time data streams without any of the above drawbacks.

The relevant prior art methods, which will deal with analysis and inspection of data streams on the Internet, are as follows:

U.S. Pat. No. 5,873,107 discloses a system for automatically retrieving information relevant to text being authored. Text entry and information retrieval are combined in such a way as to automatically offer an author continuous retrieval of information potentially relevant to the text he is authoring.

U.S. Pat. No. 5,361,359 claims a system and method for auditing and controlling the use of a computer. The invention may be configured to collect user audit data concerning user activity and system status and to write the audit data to the protected media and to limit execution of application programs to the approved applications.

U.S. Pat. No. 5,649,186 details a system and computer-based method providing a dynamic information clipping service.

U.S. Pat. No. 5,997,476 discloses a networked system for communicating information to an individual and for remotely monitoring the individual. The system includes a server and a remote interface for entering in the server a set of queries to be answered by the individual. The server is preferably a web server and the remote interface is preferably a personal computer or remote terminal connected to the server via the Internet.

U.S. Pat. No. 6,078,914 describes a meta search system that accepts natural language queries which are parsed to extract relevant content, this relevant content being formed into queries suitable for each of a selected number of search engines and being transmitted thereto.

U.S. Pat. No. 6,141,694 claims a method and apparatus for determining and verifying user data. One or more facts about the user of a client system such as an internet terminal are maintained in a set of information fields, each information field is associated with a status field for indicating a level of certainty regarding the accuracy of the information contained in the corresponding information field.

U.S. Pat. No. 6,366,956 provides an information access monitor that is located at the Internet gateway of a network. The information access monitor monitors information flows between the internal data communication network and Internet to identify information requests and responses. The Information Access Monitor generates relevance indexes for these requests and responses and compiles a “corporate consciousness” of all data relevant to the organization. The information access monitor computes user/group profiles to identify information needs and interests within the organization and can then automatically associate users/groups with information of relevance.

U.S. Pat. No. 6,401,118 details a system, method and computer program product that allows an organization, company, or the like to monitor the Internet (or any computer network) for violations of their intellectual property (e.g., patent, trademark or copyright infringement), or monitor how persons on the Internet view their business, products and/or services. The system includes a Web server for receiving search requests and criteria from users on a Web client and a server for searching the Internet for URL's that contain contents matching the search criteria, thereby compiling a list of offending URL's.

U.S. Pat. No. 6,571,313 discloses a memory for searching information through prefix analysis, in particular for building routing tables for nodes of high speed communication networks, such as Internet network, has a memory element which stores a set of information items each associated with a mask information indicative of the number of significant characters in the respective prefix and with a target information.

U.S. Pat. No. 7,321,892 provides a computer-implemented process that identifies useful alternative spellings of search strings submitted to a search engine. The process takes into consideration spelling changes made by users, as detected by programmatically analyzing search string submissions of a population of search engine users. In one embodiment, an assessment of whether a second search string represents a useful alternative spelling of a first search string takes into consideration (1) an edit distance between the first and second search strings, and (2) a likelihood that a user who submits the first search string will thereafter submit the second search string, as determined by monitoring and analyzing actions of users.

However the purpose and methodology of the above inventions that are part of prior art do not envisage an improved method that allows for generic matching.

Further most of the above applications use specific keywords to match words and identify patterns in the data streams. This kind of search will be limited.

Again the inspection of data streams in real time is not envisaged in the prior art.

Accordingly, there is a need for an advanced analysis system and process that can be used to identify patterns in real time data streams.

In view of the limitations now present in the prior art, the present invention provides a method and process for the forensic inspection real time data streams.

It will be apparent to those skilled in the art that the objects of this invention have been achieved by providing regular expressions to analyze incoming streams of data in a unique manner unlike existing models. Various changes may be made in and without departing from the concept of the invention. Further, features of some stages disclosed in this application may be employed with features of other stages. Therefore, the scope of the invention is to be determined by the terminology of the following descriptions, claims, drawings and the legal equivalents thereof.

### SUMMARY OF THE INVENTION

This invention may be summarized, at least in part, with reference to its objects. Accordingly several advantages and objects of the present invention are as follows:

A principal objective of the present invention is to provide a method and process for facilitating the analysis and inspection of real time data streams

Another objective of the present invention is to provide a method and process that will alert the subscriber (guardian/parent) when a certain pattern is matched.

Yet another objective of the present invention is to parse incoming chat/instant messages using predefined regex expressions, where an alert is sent to the subscriber on a match being established.

A further objective of the present invention is to parse incoming email using predefined regex expressions, where an alert is sent to the subscriber on a match being established.

It is intended that any other advantages and objects of the present invention that become apparent or obvious from the detailed description or illustrations contained herein are within the scope of the present invention. Thus the above and other objects of the present invention will be more readily apparent when considered in reference to the following description and when taken in conjunction with the accompanying drawings.

### DESCRIPTION OF THE INVENTION

The following description is presented to enable any person skilled in the art to make and use the invention, and is provided in the context of particular applications of the invention and their requirements. The present invention can be configured as follows:

The purpose of the present invention is to provide a method and process for facilitating the analysis and inspection of real time data streams, which will allow a user to actively monitor chat and email information. The present invention will inspect a plurality of user browsing information such as, but not limited to, the web pages and search queries respectively visited and submitted by users, the emails sent and received by users, and the manner in which users browse the Internet and search for content. It is also a purpose of the present invention to provide a method and process that has many novel features not offered by the prior art applications and which is not apparent, obvious, or suggested, either directly or indirectly by any of the prior art applications.

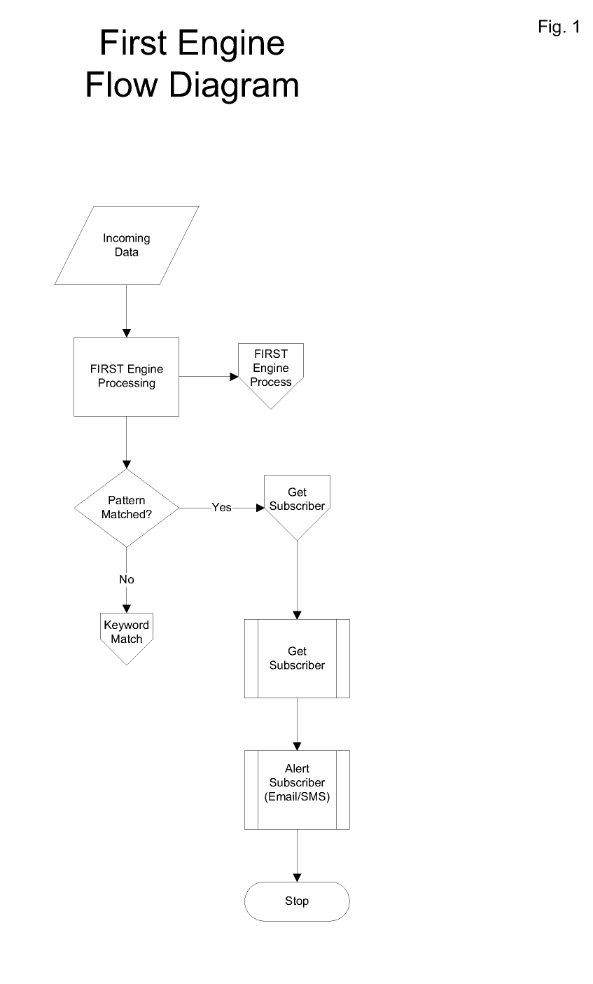

FIG. 1 is a flow chart diagram detailed the general working of the present invention

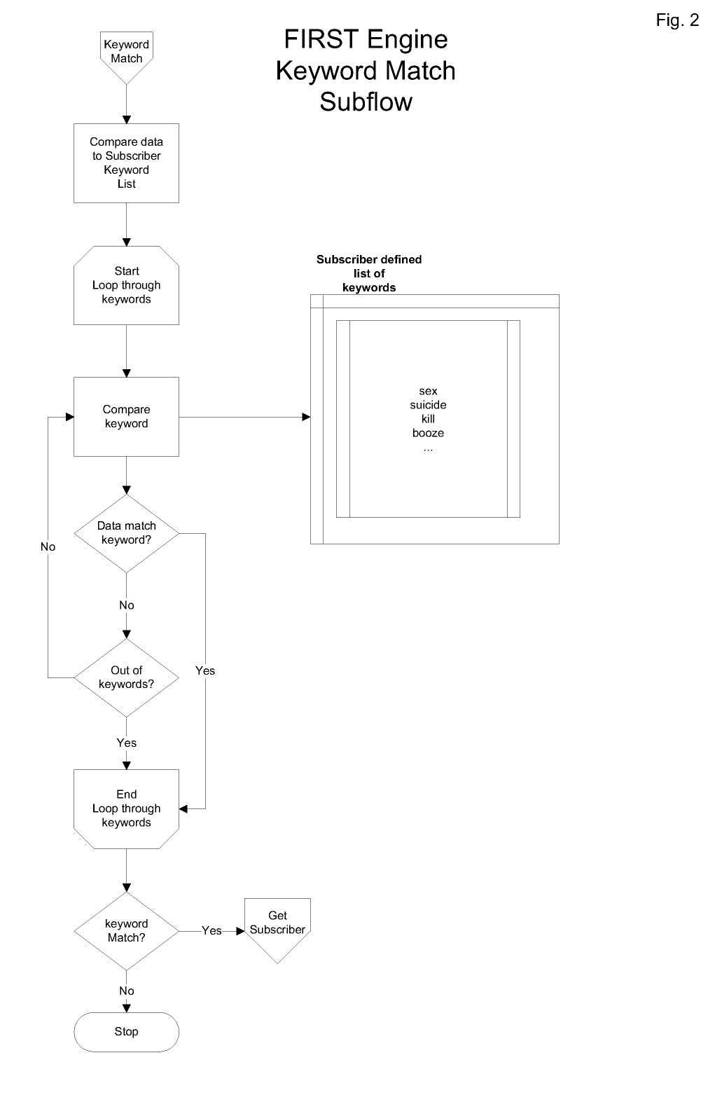

FIG. 2 is a flow chart diagram detailed the keyword match subflow in the working of the present invention

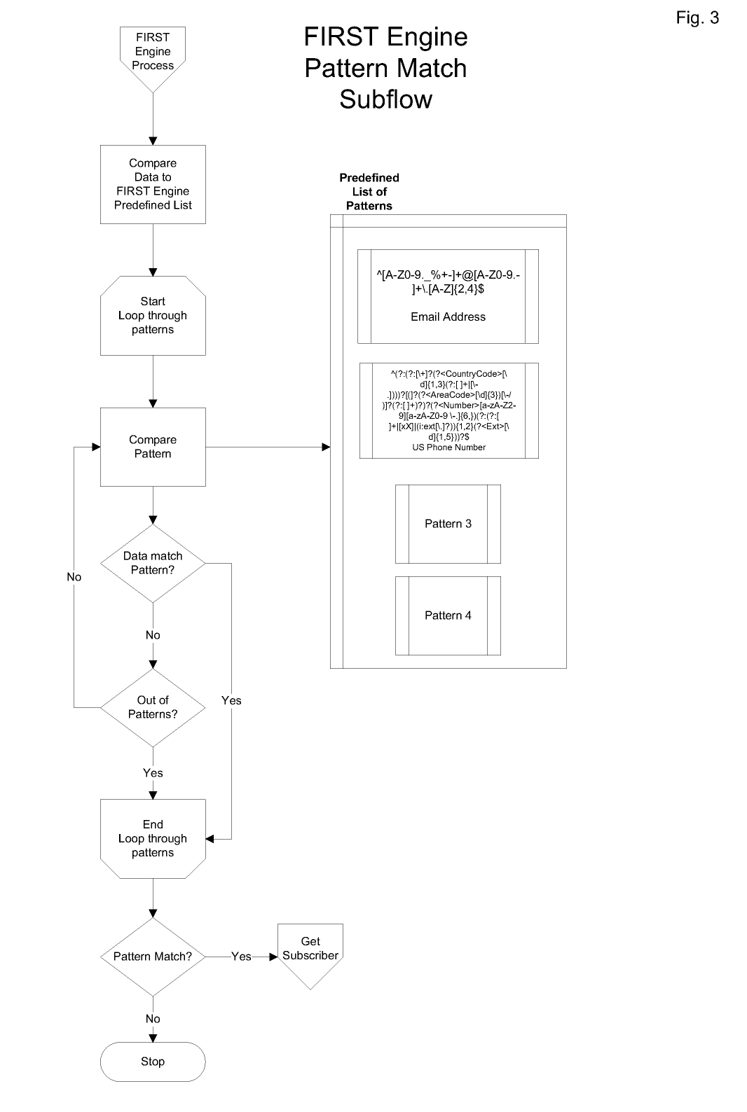

FIG. 3 is a flow chart diagram detailed the pattern match subflow in the working of the present invention

The present invention in the preferred embodiment generally comprises computer software, including internet web page based code, and methods of applications using regular expressions to analyze incoming streams of data. If a pattern is matched it will return a true if not a false.

The present invention will include one or a multitude of computer code based filters that will act to analyze the data streams. The filters may utilize keyword match, pattern match or other specific identifiers or parameters not referred to herein which will assist in matching the data streams to the predefined table.

In the preferred embodiment, user input is first captured and sent to a centralized server as detailed in FIG. 1. The captured data is in xml format. The xml formatted data is then parsed using regular expressions in php script. A predefined table of patterns and/or keywords is on centralized server. Captured data is compared (grep or other unix style method) to the predefined table. If the data matches the pattern a flag is marked true. If the data does not match, it passes through to the keyword match. If the data matches the keyword a flag is marked true. If the data does not match it simply passes through the engine. If the flag is true, then additional processing can be performed. One of which is to send an email or SMS to the subscriber set in their profile.

As detailed in FIG. 2, the keyword match envisages comparing the captured data to a predefined list of keywords suggested by the subscriber such as but not limited to ‘sex’, ‘suicide’, ‘booze’, ‘kill’, etc. The invention starts the loop through these keywords, and tries to compare the captured data to these keywords. If a match is established, the subscriber is notified, if a match is not established; the data simply passes through the engine.

As detailed in FIG. 3, the pattern match envisages comparing the captured data to a predefined table of patterns suggested by the subscriber such as but not limited to the email addresses used, the phone number used, etc. The invention starts the loop through these patterns, and tries to compare the captured data to these patterns. If a match is established, the subscriber is notified, if a match is not established, the data simply passes through the engine.

Children's chats/IM's and email are thus monitored and sent back to the central server. These chats are parsed with the present invention, using a predefined table of patterns or keywords looks for matches in the incoming chat streams. If a match is made, the subscriber is notified via SMS or email.

It is to be understood that the present invention in the preferred embodiment is a web based application written in PHP. It is also to be understood that other platforms, systems, languages, or coding methods may be utilized to create or make additions to the main website that performs the same function and are therefore to be considered apparent and obvious to the disclosure contained herein.

Further the foregoing has outlined, in general, the physical aspects of the invention and is to serve as an aid to better understanding the intended use and application of the invention. The invention may be embodied by a computer program that is executed by a processor within a computer as a series of computer-executable instructions. The examples of parsing specifically point out preferred embodiments of the present invention, and are not to be construed as limiting in any way the remainder of the disclosure. Such examples are non-limiting in that one of ordinary skill (in view of the above) will readily envision other permutations and variations on the invention without departing from the principal concepts. Such permutations and variations are also within the scope of the present invention.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. Method and process for the forensic inspection of realtime streams characterized in that the said invention facilitates the analysis and inspection of data streams to allow a user to actively monitor email information.

2. Method and process for the forensic inspection of real-time streams as claimed in claim 1 wherein the said invention facilitates the analysis and inspection of data streams to allow a user to actively monitor chat information.

3. Method and process for the forensic inspection of real-time streams as claimed in claim 1 wherein the said invention includes one or a multitude of computer code based filters that act to analyse and inspect the data streams.

4. Method and process for the forensic inspection of real-time streams as claimed in claim 1 wherein the said invention captures user input in xml format and sents it to a centralized server.

5. Method and process for the forensic inspection of real-time streams as claimed in claim 1 wherein the said xml formatted data is parsed using regular expressions in php script.

6. Method and process for the forensic inspection of real-time streams as claimed in claim 1 wherein the said captured data is compared in grep or other unix style method to a predefined table of patterns and/or keywords.

7. Method and process for the forensic inspection of real-time streams as claimed in claim 1 wherein the said data is marked true with a flag if a match is established with the said pattern.

8. Method and process for the forensic inspection of real-time streams as claimed in claim 1 wherein the said data passes through to the keyword match if it does not match.

9. Method and process for the forensic inspection of real-time streams as claimed in claim 1 wherein the said data is marked true with a flag if a match is established with the said keyword.

10. Method and process for the forensic inspection of real-time streams as claimed in claim 1 wherein the said data passes through the engine if there are no matches.

11. Method and process for the forensic inspection of real-time streams as claimed in claim 1 wherein an email or SMS is dispatched to the subscriber in case of an established pattern or keyword match.
